(19) United States
(12) Patent Application Publication
(10) Pub. No.: US 2010/0110954 A1
(43) Pub. Date: May 6, 2010

(54) METHOD AND SYSTEM FOR SYNCHRONIZATION BETWEEN APPLICATION LAYER CONTROLLERS AND WIRELESS DEVICE

(76) Inventor: Anil Kumar, Gurgaon (IN)

Correspondence Address: BAKER & DANIELS LLP, 300 NORTH MERIDIAN STREET, SUITE 2700, INDIANAPOLIS, IN, 46204, US

(21) Appl. No.: 12/532,570

(22) PCT Filed: Mar. 17, 2008
(86) PCT No.: PCT/IN08/00153

§ 371 Date: Sep. 22, 2009

(30) Foreign Application Priority Data
Mar. 16, 2007 (IN) 576/DEL/2007

(51) Int. Cl. G08C 17/00

(52) U.S. Cl. 370/311

(57) ABSTRACT

Method and system for synchronizing the working of the application layer functions with the wireless device functions. More particularly, core and management functions of layer 2 and layer 3 applications in wireless systems such as handheld device and base station, wherein there is a need for close frame timing synchronization at application layer. The method and system fulfills the requirements of supporting hard real-time latencies introduced between the user space and kernel space in standard operating systems used in designing of system for wireless application.

### FIELD OF THE INVENTION

The present invention discloses a new technique for synchronizing the working of the application layer functions with the wireless device functions. More particularly, it pertains to core and management functions of layer 2 and layer 3 applications in wireless systems such as handheld device and base station, wherein there is a need for close frame timing synchronization at application layer. It also fulfill the requirements of supporting hard real-time latencies introduced between the user space and kernel space in standard operating systems used in designing of system for wireless application.

### BACKGROUND OF THE INVENTION

The use of off-the-shelf hardware and general purpose operating platforms for implementing wireless devices has been on the rise as a result of a number of factors. These include:
Development of highly reliable, standardized processing cards at very low prices
Commodity backplanes such as PCI-X and lately, ATCA, which allows easy internetworking between proprietary channel card hardware and general purpose processing cards
An increasing desire for operators to reduce their dependence on proprietary hardware and consequently, single vendor dependence and consequently, significantly decrease operating costs
An impressive increase in form-factor technology, which allows for highly dense architectures supporting very high power CPUs and memory
Availability of free, powerful and customizable operating systems such as Linux and FreeBSD
Availability of portable software platforms and components for various functionality under GPL

This trend is expected to be increasingly dominant in the future. One of the aims of the standardization bodies working in different wireless technologies is to allow development of highly sophisticated, yet cheap devices such as base station, mobile phone etc. It is very likely that these wireless devices will run on standard operating platforms, with added special purpose cards for the wireless channel support and other specialty needs of applications.

As shown in FIG. 1, the existing standard software architecture for a wireless base station mainly consists of three parts. The first part includes the device driver, which is the software component that directly interacts with the wireless hardware. Its most immediate task is to give data to the wireless device for transmission and accept data during reception. There are many ways by which this can be achieved i.e. direct memory mapping between the device driver's internal memory and the driver, explicit DMA, etc.

The second component comprises of the network device driver which provides the interface between the device driver itself and the IP stack. This is commonly known as data-path.

The final layer is the control layer, which exists as one or more daemon processes at the application level. Control information to be transmitted/received is passed between the device driver and the control layer using some form of kernel to user plane IPC.

The above architecture, described in FIG. 1, presents the technical disadvantage of latency that is introduced between the user space and the kernel space. This latency is introduced primarily because of the single threaded system call interface and the scheduling of processes within the kernel, which in standard operating systems do not really support hard-real-time latencies. However, in many of the modern wireless specifications these latencies are very critical since many timers and events are frame synchronous.

Since these timers are of few msecs, implementation often uses high precision timer implementation. This leads to higher rate of timer interrupt and this further increases latency. This leads to timing slip with respect to frame number and reduces the overall capacity.

### SUMMARY OF THE INVENTION

In order to overcome the above-mentioned drawbacks and achieve the above objectives and advantages, the instant invention describes a method which allows an application layer module to wait for a specific frame number wherein the waiting duration can be specified in a variety of terms. It may be expressed as an absolute frame number, a frame number relative to a particular super-frame boundary, a frame number relative to the current frame, or number of frames.

Synchronization between the application layer modules and the wireless device is achieved as the application layer module in waiting gets signaled whenever that frame start boundary is detected by the wireless device driver. Framing signals may be generated by the wireless chip set or derived from the frame synchronous clock. As a result the application layer gets a wake up signal on precise frame boundary and its timings are synchronized with the frame timings. It also does not add extra processing such as increasing timer interrupt while achieving synchronization. As a result, it allows an application in user space to synchronize with frame based events. Same mechanism can also be used by the kernel application to further optimize the system processing.

As an added advantage, the application layer module is not limited by the granularities of the system timer. Further, it is also not impacted, by change in system time.

### BRIEF DESCRIPTION OF THE DRAWINGS

The detailed description of the present invention is described with reference to the accompanying figures.

FIG. 1 depicts a standard architecture for a wireless base station

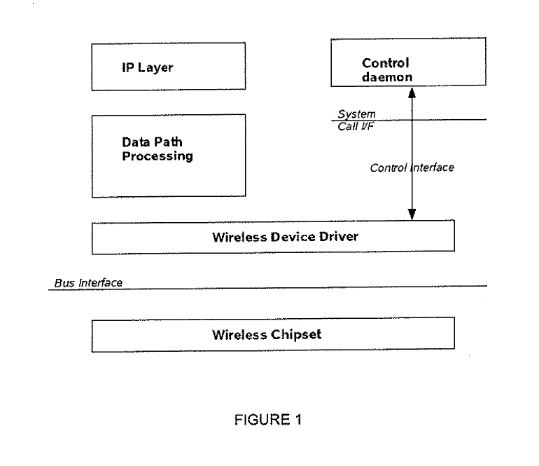

FIG. 2 illustrates the solution architecture of the present invention

FIG. 3 depicts the flow diagram of the present invention

FIG. 4 describes an embodiment for the implementation of the present invention based on the Linux kernel

FIG. 5 shows another embodiment for the implementation of the present invention

### DETAILED DESCRIPTION OF THE INVENTION

A method and system for synchronization between application layer controllers and wireless device are described, The system and methods are not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The present invention provides an efficient and compact solution to avoid latency during system operation while maintaining the overall capacity. The application in waiting gets signaled up whenever a desired frame number start boundary is detected by the device driver. Framing signals may be generated by the wireless chip set or derived from frame synchronous clock.

One of the advantages of the present invention includes that the application gets a wake up signal on precise frame boundaries. As a result, the application timings are synchronized with the network timing/frame timing. Also, the application is not limited by the granularities of the system timer such as fractional values. Further, the application is not impacted by change in system time.

The solution offered by the present invention does not add extra processing such as increasing the number of timer interrupt and processing time thereof. It also allows an application in user space to synchronize with frame based events. It also fulfills the requirement of supporting hard real time latencies between user space and kernel space applications under standard operating systems. It further supports arbitrary frame size, does not require knowledge of frame size and is not impacted by the system time change.

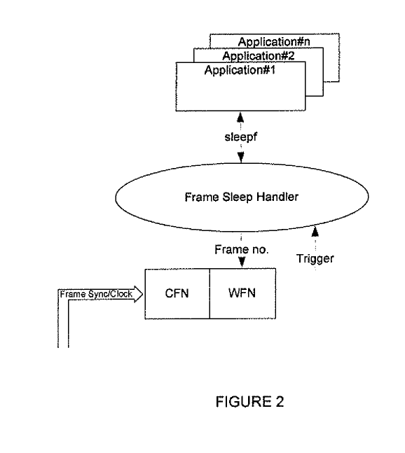

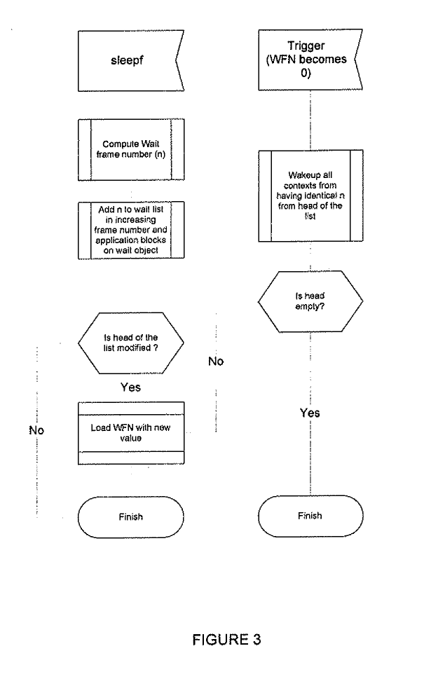

In order to describe the implementation of the instant invention, with reference to FIG. 2 and FIG. 3, we may define two variables: CFN, the current frame number and WFN, the wait frame numbers i.e., the frame number for which an application is waiting. CFN acts like an accumulator and is incremented for every frame. Its value is put to zero every time the wireless interface is reset or initialized. WFN is decremented by m (decrement factor), which depends upon the system implementation or requirements.

An API sleepf is defined, which is invoked by the application. It can be invoked by the multiple application modules for waiting of same frame number or different frame number without impacting each other behavior. An invoking application module may block (synchronous operation) or continue working (asynchronous operation). The frame sleep handler computes the frame number for which the application wants to wait and updates WFN accordingly. For this computation, the frame sleep handler uses CFN and m.

When WFN reaches zero, an OS dependent event is generated. This event according to synchronous or asynchronous invocation of sleepf unblocks and/or signals all the application modules that are waiting for the corresponding frame number.

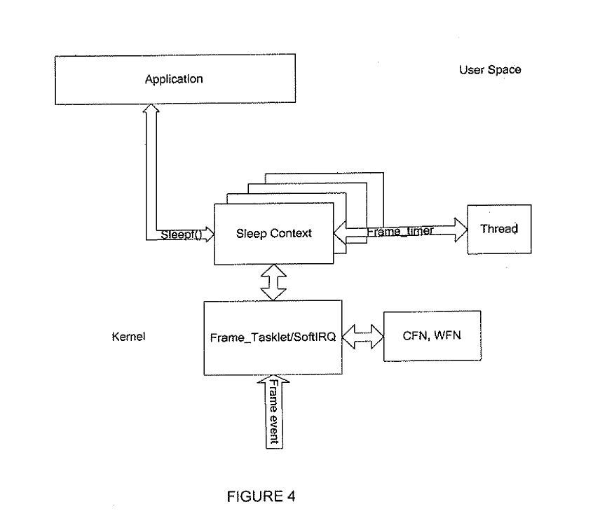

There are many possible ways to implement the solution proposed by the present invention. FIG. 4 shows an embodiment of the implementation of the present invention. It is described for LINUX but does not exclude other operating systems:
WFN and CFN are managed by the kernel software
Sleep handler is implemented as part of sleepf system call and Frame_tasklet/softIRQ handles frame sync/clock interrupt/event

Frame_Tasklet/SoftIRQ handles the frame events generated by wireless chipset driver or network clock (frame sync) softlRQ. The tasklet manages CFN and WFN. CFN behaves like an accumulator and WFN is the number of frames to wake up the sleep context on the head of the sleep context list. One or more sleep contexts are woken up when WFN reaches zero. Sleep contexts are linked in a differential doubly link list

For kernel threads frame_timer API is provided, which lets the kernel thread sleep in a similar fashion as an application process/thread but follows the kernel threading semantics.

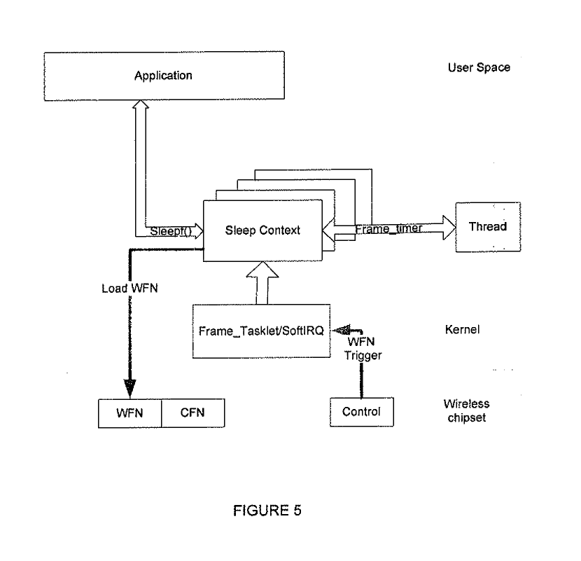

FIG. 5 shows another embodiment of the implementation of the present invention also based on the Linux kernel. This approach also does not exclude other operating systems. Here CFN and WFN are managed by the wireless chipset. In this approach:
WFN and CFN are managed by the wireless chipset
Sleep handler is implemented as a part of the sleepf system call and tasklet/softIRQ handling WFN interrupt/event

Frame number of sleep context on the head of the list is loaded into the hardware register and activated. When WFN reaches zero, an interrupt is generated which leads to the one or more context from sleep context list gets woken up.

The present invention is not intended to be restricted to any particular form or arrangement, or any specific embodiment, or any specific use, disclosed herein, since the same may be modified in various particulars or relations without departing from the spirit or scope of the claimed invention herein shown and described of which the apparatus or method shown is intended only for illustration and disclosure of an operative embodiment and not to show all of the various forms or modifications in which this invention might be embodied or operated

We claim:

1. A method for achieving synchronization between one or more application layer modules and associated wireless device, said method comprising the steps of:
accepting one or more wait requests from said one or more modules each comprising a wait duration;
computing the ‘frame number to wait’ corresponding to said wait duration;
adding each wait request to the waiting list in increasing order of ‘frame number to wait’;
making said module wait;
receiving a frame sync signal;
computing the current frame number from said frame sync signal;
removing the wait request at the head of said list if the ‘frame number to wait’ of said request is the same as the current frame number; and
sending a wakeup trigger to one or more modules associated with the removed request

2. A method as claimed in claim 1, wherein said wait duration is specified in terms of an absolute frame number

3. A method as claimed in claim 1, wherein said wait duration is specified in terms of frame number relative to a particular super-frame boundary

4. A method as claimed in claim 1, wherein said wait duration is specified in terms of time relative to the current frame

5. A method as claimed in claim 1, wherein said wait duration is specified in terms of absolute time

6. A method as claimed in claim 1, wherein said module waits by suspending execution until said wakeup trigger is received

7. A method as claimed in claim 1, wherein said module waits by continuing execution until said wakeup trigger is received

8. A method as claimed in claim 1, wherein said one or more modules are associated with the same ‘frame number to wait’

9. A method as claimed in claim 1, wherein said one or more modules are associated with different ‘frame numbers to wait’

10. A method as claimed in claim 1, wherein said one or, more modules do not impact each other's behaviour while waiting

11. A method as claimed in claim 1, wherein said frame sync signal is derived from wireless chipset generated frame synchronous signal

12. A method as claimed in claim 1, wherein said frame sync signal is derived from frame synchronous system clock

13. A system for achieving synchronization between one or more application layer modules and associated wireless device, comprising:
first input means configured to accept one or more wait requests from said one or more modules;
second input means configured to receive a frame sync signal;
memory coupled to said first input means configured to store said requests in the wait list in one or more formats;
processor coupled to said first and second input means and memory, programmed to process and analyze said wait requests, said processor comprising means configured to convert wait duration of said wait requests into ‘frame number to wait’, means configured to add each wait request to the waiting list in increasing order to ‘frame number to wait’, means configured to make said module wait, means configured to compute the current frame number from received frame sync signal, means configured to remove the wait request at the head of said list if the ‘frame number to wait’ of said request is the same as the current frame number, means configured to send a wakeup trigger to one or more modules associated with the removed request; and
output means coupled to said processor configured to activate said one or more modules on expiry of said wait duration
